(19) United States
(12) Patent Application Publication
(10) Pub. No.: US 2020/0337357 A1
(43) Pub. Date: Oct. 29, 2020

(54) FOOD PACKAGING FILMS CONTAINING NATURAL ANTIBACTERIAL COMPONENT

(71) Applicant: QILU UNIVERSITY OF TECHNOLOGY, Jinan (CN)

(72) Inventors: Chao Yuan, Jinan (CN); Bo Cui, Jinan (CN); Li Guo, Jinan (CN); Bin Yu, Jinan (CN); Yishan Fang, Jinan (CN); Yiyuan Zou, Jinan (CN)

(21) Appl. No.: 16/728,186

(22) Filed: Dec. 27, 2019

(30) Foreign Application Priority Data
Apr. 28, 2019 (CN) 201910348761.9

(51) Int. Cl. A23P 20/20; B65D 65/46; A23L 29/30

(52) U.S. Cl. CPC A23P 20/20; A23L 29/35; B65D 65/463

(57) ABSTRACT

The invention relates to edible films, and more particularly to a method for preparing a food packaging film with antibacterial activity. By adding konjac glucomannan and glycerin in starch to obtain a composite film, the aggregation and rearrangement effect among molecules of amylose starch can be weakened, the defects such as high brittleness and low ductility of high-amylose corn starch can be improved, and, since the konjac glucomannan is rich in dietary fiber that is slowly digestible, a low-calorie edible packaging film can be produced by compounding. By adding the embedded product of perilla oil and cyclodextrin in the mixed dispersion of high-amylose corn starch and konjac glucomannan to prepare an active film, the film can have a smoother surface and more perfect and uniform structure, and also, the composite film can have a function of bacteria inhibition.

### CROSS-REFERENCE TO RELATED APPLICATIONS

This application claims the benefit of priority from Chinese Patent Application No. CN201910348761.9, filed on Apr. 28, 2019. The content of the aforementioned application, including any intervening amendments thereto, is incorporated herein by reference in its entirety.

### TECHNICAL FIELD

The present invention belongs to edible films and relates to a method for preparing a food packaging film with antibacterial activity, in particular to a method for preparing a composite edible film, containing antibacterial components, from high-amylose corn starch and konjac glucomannan.

### BACKGROUND OF THE PRESENT INVENTION

With the growth of the population and the advancement of the modernization process, the environmental pollution caused by the abuse of petroleum-based materials is becoming increasingly serious. Statistically, in 2016, about 3.3 billion plastic bags were consumed every day in the world, and the white pollution caused by the heavy use of plastic bags has already attracted wide attention. Therefore, in 2015, 28 EU members have passed a law to reduce the use of thin plastic bags, and in December 2018, passed a proposal to ban various disposable plastic products. In fact, as early as 2008, China has implemented the “plastic limit”, but the effect is not satisfactory. The main reason is the difficulty in changing people's consumption habits and the convenience of using plastic bags. Therefore, in addition to restricting the use of non-degradable plastic packaging bags in legislation and system, we should actively seek alternative renewable green materials to solve the current problems.

As a renewable polymer, starch has been widely used in food, medical, and degradable plastics industries. In the food industry, there are many studies on the preparation of degradable and edible films by compounding starch with lipids, proteins or polysaccharide gums or small molecular substances. For example, high-amylose corn starch is mixed with sorbitol or gelatin to prepare a starch film or chewing gum that may be used as drug sustained-release carrier to treat oral diseases or to fresh breath; potato starch and Tween 20 or soy lecithin are prepared into a more flexible edible film; starch, chitosan, and essential oil are prepared into a starch film that inhibits postharvest fungi, which has good mechanical strength and water resistance; biodegradable starch film material prepared by mixing polylactic acid resin, soft degradable material and starch can be used in the production of food bags, in replacement of traditional film materials; and so forth. Amylose starch plays an important role in the formation of crosslinked structures during the film formation of starch by compounding. The difference in the content of amylose directly affects the properties and applications of starch. High-amylose starch with a content of amylose exceeding 50% is the best raw material for producing plastics, and it is also an effective way to solve the current “white pollution”.

However, on one hand, the pure starch film prepared from high-amylose starch, for example high-amylose corn starch, has problems such as aging and brittleness, so it is often compounded with a plasticizer, for example glycerin, in the application process to prevent the recrystallization of the starch chains, in order to inhibit aging and improve mechanical properties. In addition, the addition of a gel to the starch film can also effectively improve the structure and properties of the starch-based film. For example, the starch film prepared from high-amylose starch, the glycerin and chitosan have significantly decreased crystallinity and significantly increased toughness. The starch-based film obtained by compounding with glycerin, gellan gum or xanthan gum can have solubility and mechanical properties comparable to the commercial pullulan polysaccharide film, so it can be used as a drug sustained-release carrier in replacement of the pullulan polysaccharide film to save lots of cost; due to the hydrophobic net structure that can be formed by gelatin with the starch chains, starch can be compounded with gelatin and glycerin to decrease the solubility of the starch-based film and improve its water-blocking properties; and so forth. Konjac glucomannan, as one of the non-starch polysaccharide gums, can also be compounded with starch, for example pea starch and tapioca starch, to prepare starch-based edible films. Konjac glucomannan is the main component of konjac glucomannan, and it is also the one with highest viscosity of all plant-based water-soluble edible gums found so far. It is generally used as a thickener, stabilizer or gelatinizer in food. The preparation of edible packaging films or coatings by combining konjac glucomannan with starch can reduce the use of petroleum-based plastic packaging bags while widening the applications of starch and konjac glucomannan in food.

On the other hand, the waste of resources caused by improper food packaging is also an urgent problem to be solved. In addition to the problems of the packaging materials themselves, unqualified plastic packaging bags are likely to cause excessive benzene solvent residues; fluorescent agents, mineral oils, etc. may be present in paper packaging products; improper packaging methods and poor antibacterial effects may cause premature spoilage and deterioration of food. In view of this problem, people turned their attention to active packaging. The active packaging by using the starch film is, by adding some antibacterial substances such as plant essential oil, polyphenols and nisin in the starch film, to produce stable and long lasting antibacterial activity through the sustained release of the antibacterial agents, to reduce the use of synthetic additives, in order to achieve the antibacterial and antiseptic purposes.

### SUMMARY OF THE PRESENT INVENTION

In view of the problems of the traditional food packaging films, the present invention provides a method for preparing a food packaging film with antibacterial activity.

For this purpose, the present invention is implemented by the following technical solutions.

A method for preparing a food packaging film with antibacterial activity is provided, comprising:

(1) dissolving cyclodextrin (β-cyclodextrin or hydroxypropyl-β-cyclodextrin) powder in deionized water to prepare a cyclodextrin solution, and dissolving perilla oil in ethanol to obtain a perilla oil solution;

(2) mixing the cyclodextrin solution with the perilla oil solution, and magnetically stirring the reaction mixture under sealing and insulation to embed the perilla oil in the cyclodextrin to obtain an embedded product;

(3) filtering the embedded product to remove extra cyclodextrin, freezing and lyophilizing the filtrate, and sealing and storing the lyophilized product in a cool and dark place;

(4) dissolving a high-amylose corn starch in deionized water to obtain a starch dispersion, uniformly mixing the starch dispersion followed by stirring under heating to obtain a starch solution;

(5): processing the starch solution in an autoclave to gelatinize the high-amylose corn starch to obtain a starch paste;

(6) adding konjac glucomannan and glycerin to the starch paste, adding the lyophilized product obtained in step (3), and uniformly mixing the reaction mixture under magnetic stirring to obtain a film-forming liquid; and

(7) degassing the film-forming liquid under vacuum, subjecting the degassed film-forming liquid to tape casting to produce a crude film, and quickly drying the crude film by an infrared tunnel dryer to produce a starch-based composite film containing cyclodextrin supermolecules as the food packaging film.

Preferably, in the step (1), the cyclodextrin solution comprises 2%-6% by weight of cyclodextrin; the perilla oil solution comprises 20%-60% (w/v) of the perilla oil, and is prepared according to a core-to-wall ratio by mass of 1:6-10.

Preferably, in the step (2), the magnetic stirring is performed at 40-60° C. and 200-220 rpm for 3-5 h; and a volume ratio of the cyclodextrin solution to the perilla oil solution is (90-100):1.

Preferably, in the step (3), the freezing is performed at −20 to −25° C. for 24-48 h; and the lyophilization lasts for 45-50 h.

Preferably, in the step (4), the starch dispersion comprises 3%-5% by weight of the high-amylose corn starch; and the stirring under heating is performed at 85-95° C. and 200-220 rpm for 25-35 min.

Preferably, in the step (5), the gelatinization is performed at 125-130° C. and 2.0 MPa for 25-30 min.

Preferably, in the step (6), the embedded product is 1%-5% by weight of the konjac glucomannan, glycerin and the starch paste; the magnetic stirring is performed at room temperature and 400-450 rpm for 40-60 min; the konjac glucomannan and the glycerin are respectively 0.2%-0.5% and 1%-2% by weight of the starch paste; in step (7), the degassing is performed at a vacuum degree of 0.08-0.1 MPa for 5-15 min; and the drying is performed at 50-60° C. for 3-5 h.

The present invention provides use of the food packaging film with antibacterial activity described above to the packaging of food.

The present invention provides use of the food packaging film with antibacterial activity described above to the packaging of candies, hawthorn rolls, jerky or bread.

The present invention will be described below by using perilla oil as an example. Perilla is one of the first batch of medical and edible plants promulgated by the Ministry of Health. The perilla oil, extracted from perilla, is a renewable resource that can be added to foods and that has antibacterial, antiseptic and antioxidant functions. Embedding perilla oil with cyclodextrin (for example, β-cyclodextrin, γ-cyclodextrin, hydroxypropyl-β-cyclodextrin, etc.) can improve the water solubility of perilla oil, slow down the volatilization of perilla oil, and regulate the sustained release of perilla oil. The growth and reproduction of some microorganisms such as molds in foods will be subject to factors such as temperature and water activity. The sustained release of active components in the active packaging film will also increase with the increase of temperature and water activity. Therefore, the starch-based film containing perilla oil can effectively reduce the influence on the quality of food from biological reproduction caused by the fluctuation of these factors, and realize the intelligent regulation of food preservation.

In the present invention, by adding embedded product of cyclodextrin (β-cyclodextrin, hydroxypropyl-β-cyclodextrin) and perilla oil to the starch-konjac glucomannan dispersion, and by using glycerin as a plasticizer, an edible composite active packaging film containing cyclodextrin supermolecules (a natural antibacterial component) is prepared, which is used for preserving fruit, meat, bread and the like, so as to extend the shelf life of the food.

Compared with the prior art, the present invention has the following advantages and beneficial effects:

The konjac glucomannan molecule contains a large amount of hydrophilic groups such as hydroxycarbonyl groups, and thus can bind a large amount of water to form a gel. After adding konjac glucomannan to the starch dispersion, the konjac glucomannan and the starch chains can form a stable net structure through hydrogen bonds, inhibiting recrystallization of the starch chains, thereby delaying the aging of the starch-based film. Moreover, the konjac glucomannan has a film-forming property, and the composite film formed by the konjac glucomannan and starch is uniform and dense and has good water repellency, so it can be used as a renewable packaging material applied in the food packaging industry. Starch, as the main energy storage method for green plants, on one hand, can be completely degraded without producing toxic and harmful substances that endanger human health or pollute the environment, and on the other hand, high-amylose corn starch can also provide the necessary carbohydrates for human metabolism and the energy for maintaining vital signs. Therefore, by adding konjac glucomannan and glycerin in starch to obtain a composite film, the aggregation and rearrangement effect among molecules of amylose starch can be weakened, the defects such as high brittleness and low ductility of high-amylose corn starch can be improved, and, since the konjac glucomannan is rich in dietary fiber that is slowly digestible, a low-calorie edible packaging film can be produced by compounding.

Perilla oil smells sweet and has a function of bacteria inhibition. Embedding perilla oil with cyclodextrin (β-cyclodextrin, hydroxypropyl-β-cyclodextrin) realizes the solubilization and sustained release of perilla oil. In addition, cyclodextrin easily forms hydrogen bonds with water molecules after being dissolved in water. Under this trend, other components in the dispersion are more uniformly dispersed. Therefore, by adding the embedded product of perilla oil and cyclodextrin in the mixed dispersion of high-amylose corn starch and konjac glucomannan to prepare an active film, the film can have a smoother surface and more perfect and uniform structure, and also, the composite film can have a function of bacteria inhibition. The perilla oil is released intelligently and slowly as the surrounding environment changes, during the storage of food, thereby providing more lasting bacteria inhibition effect.

### DETAILED DESCRIPTION OF THE PRESENT INVENTION

To better understand the purposes, features and advantages of the present invention, the present invention will be further described below by specific embodiments. It is to be noted that the embodiments of the present application and features in the embodiments may be combined if not conflict.

Many specific details will be explained hereinafter to facilitate the thorough understanding of the present invention. However, the present invention may be implemented in other ways rather than those described here. Therefore, the present invention is not limited to the specific embodiments to be described hereinafter.

### Embodiment 1

This embodiment provides an edible packaging film containing β-cyclodextrin supermolecules (a natural antibacterial component), which is used for preserving hawthorn rolls.

A proper amount of β-cyclodextrin powder was dissolved in deionized water to prepare a 2% (percentage by weight, similarly hereinafter) β-cyclodextrin solution. The perilla oil solution comprises 25% (w/v) of the perilla oil, and is prepared according to a core-to-wall ratio by mass of 1:8.

The cyclodextrin solution was mixed with the perilla oil solution in a volume ratio of 90:1, and the reaction mixture was magnetically stirred under sealing at 50° C. and 200 rpm for 4 h.

The reaction liquid after the embedment was filtered to remove the extra cyclodextrin, and the filtrate was frozen at −20° C. for 24 h and lyophilized for 48 h, and the lyophilized product was sealed and stored in a cool and dark place.

A high-amylose corn starch was dissolved in deionized water to obtain a 3% starch dispersion, and the starch dispersion was uniformly mixed and then stirred under heating at 90° C. and 200 rpm for 30 min.

The starch solution was processed in an autoclave at 127° C. and 2.0 MPa for 30 min, to gelatinize the high-amylose corn starch to obtain a starch paste.

0.3% (percentage by mass in the starch paste) konjac glucomannan and 1.5% (percentage by mass in the starch paste) glycerin were added to the starch paste, 1% (percentage by mass) embedded product of β-cyclodextrin and perilla oil was added, and the reaction mixture was magnetically stirred at 400 rpm for 1 h.

At the end of stirring, the film-forming liquid was degassed at a vacuum degree of 0.08 Mpa for 10 min, the degassed film-forming liquid was subject to tape casting to produce a crude film, and the crude film was quickly dried by an infrared tunnel dryer at 50° C. for 3 h to produce a starch-based composite film containing β-cyclodextrin supermolecules.

The composite packaging film was prepared in the above way. The obtained starch-based composite packaging film was cut into 10×8 cm rectangles into which fresh hawthorn rolls were packaged, vacuumized, and sealed at two ends. The hawthorn rolls can be eaten after peeling off the packaging film, or directly without peeling off the packaging film.

### Embodiment 2

This embodiment provides a composite packaging film containing hydroxypropyl-β-cyclodextrin supermolecules (a natural antibacterial component), which is used for preserving dried pork slices.

A proper amount of hydroxypropyl-β-cyclodextrin powder was dissolved in deionized water to prepare a 6% (percentage by weight, similarly hereinafter) hydroxypropyl-β-cyclodextrin solution. The perilla oil solution comprises 60% (w/v) of the perilla oil, and is prepared according to a core-to-wall ratio by mass of 1:10.

The cyclodextrin solution was mixed with the perilla oil solution in a volume ratio of 90:1, and the reaction mixture was magnetically stirred under sealing at 50° C. and 200 rpm for 4 h.

The reaction liquid after the embedment was filtered to remove the extra cyclodextrin, and the filtrate was frozen at −25° C. for 30 h and lyophilized for 48 h, and the lyophilized product was sealed and stored in a cool and dark place.

A high-amylose corn starch was dissolved in deionized water to obtain a 4% starch dispersion, and the starch dispersion was uniformly mixed and then stirred at 90° C. and 200 rpm for 30 min.

The starch solution was processed in an autoclave at 127° C. and 2.0 MPa for 30 min, to gelatinize the high-amylose corn starch to obtain a starch paste.

0.2% konjac glucomannan and 1.5% glycerin were added to the starch paste, 4% embedded product of hydroxypropyl-β-cyclodextrin and perilla oil was added, and the reaction mixture was magnetically stirred at 400 rpm for 1 h.

At the end of stirring, the film-forming liquid was degassed at a vacuum degree of 0.09 Mpa for 10 min, the degassed film-forming liquid was subject to tape casting to produce a crude film, and the crude film was quickly dried by an infrared tunnel dryer at 50° C. for 3.5 h to produce a starch-based composite film containing hydroxypropyl-β-cyclodextrin supermolecules.

The composite packaging film was prepared in the above way. The obtained starch-based composite packaging film was cut into 20×10 cm rectangles into which dried pork slices in a proper size were packaged, folded on two sides of the film, vacuumized, and sealed by a sealing machine.

### Embodiment 3

This embodiment provides a composite packaging film containing hydroxypropyl-β-cyclodextrin supermolecules (a natural antibacterial component), which is used for preserving bread.

A proper amount of hydroxypropyl-β-cyclodextrin powder was dissolved in deionized water to prepare a 5% (percentage by weight, similarly hereinafter) hydroxypropyl-β-cyclodextrin solution. The perilla oil solution comprises 55% (w/v) of the perilla oil, and is prepared according to a core-to-wall ratio by mass of 1:9.

The cyclodextrin solution was mixed with the perilla oil solution in a volume ratio of 100:1, and the reaction mixture was magnetically stirred under sealing at 50° C. and 200 rpm for 4 h.

The reaction liquid after the embedment was filtered to remove the extra cyclodextrin, and the filtrate was frozen at −20° C. for 48 h and lyophilized for 48 h, and the lyophilized product was sealed and stored in a cool and dark place.

A high-amylose corn starch was dissolved in deionized water to obtain a 4% starch dispersion, and the starch dispersion was uniformly mixed and then stirred at 90° C. and 200 rpm for 30 min.

The starch solution was processed in an autoclave at 127° C. and 2.0 MPa for 25 min, to gelatinize the high-amylose corn starch to obtain a starch paste.

0.2% konjac glucomannan and 1% glycerin were added to the starch paste, 3% embedded product of hydroxypropyl-β-cyclodextrin and perilla oil was added, and the reaction mixture was continuously stirred at 400 rpm for 1 h.

At the end of stirring, the film-forming liquid was degassed at a vacuum degree of 0.08 Mpa for 10 min, the degassed film-forming liquid was subject to tape casting to produce a crude film, and the crude film was quickly dried by an infrared tunnel dryer at 50° C. for 3 h to produce a starch-based composite film containing hydroxypropyl-β-cyclodextrin supermolecules.

The composite packaging film was prepared in the above way. The obtained starch-based composite packaging film was cut into 20×15 cm rectangles into which pieces of fresh bread or slices of bread were packaged and then sealed.

### Comparison Example

Preparation of the Starch Film

A high-amylose corn starch was dissolved in deionized water to obtain a 4% (percentage by weight, similarly hereinafter) starch dispersion, and the starch dispersion was uniformly mixed and then stirred under heating at 90° C. and 200 rpm for 30 min.

The starch solution was processed in an autoclave at 127° C. and 2.0 MPa for 25-30 min.

1% glycerin was added, and the reaction mixture was stirred at room temperature and 400 rpm for 1 h.

At the end of stirring, the film-forming liquid was degassed at a vacuum degree of 0.08 Mpa for 10 min, the degassed film-forming liquid was subject to tape casting to produce a crude film, and the crude film was quickly dried by an infrared tunnel dryer at 50° C. for 3 h, and the film was sealed and stored in a cool and dark place.

The result of performance tests of the starch-based food packaging films in the Embodiment 3 and the Comparison example is shown in Table 1. A slice of fresh bread is sealed by the active film and stored at 25° C. The change in the amount of microorganism in the bread is measured periodically. The result is shown in Table 2.

Thickness: for each kind, three films are measured by a micrometer screw gauge at five random points on each film, and an average thickness is calculated.

Tensile strength and elongation at break: by a method described in ASTM D-882, the starch film and its composite film are cut into 140×15 mm strips which are tested by an electronic tensile analyzer in terms of tensile strength and elongation at break.

Transparency: the light transmittance is measured by an ultraviolet spectrophotometer. The film is cut into strips laminated on the surface of the cuvette, and the light absorptivity of the film is measured at 600 nm. The calculation method is as follows: T=A600/M, where M is the thickness of the film (mm). A higher T indicates a lower transparency of the film.

Coefficient of moisture permeability: the film is cut into pieces having a diameter of 6 cm, and the coefficient of moisture permeability after 12 h is measured by a moisture permeability analyzer.

TABLE 1
Performance parameters of the food packaging film

| | | | | | Coefficient |
|---|---|---|---|---|---|
| | | | | | of moisture |
| | | Tensile | Elongation | | permeability |
| | Thickness | strength | at break | Transparency | (g.cm/ |
| Item | (μm) | (MPa) | (%) | (T) | cm2.s.Pa) |
| Embodiment | 112 ± 4 | 10.07 ± 0.25 | 54.77 ± 0.41 | 3.31 ± 0.21 | 2.408 × 10 − 12 |
| 1 | | | | | |
| Comparison | 89 ± 2 | 4.34 ± 0.22 | 15.94 ± 0.15 | 2.86 ± 0.16 | 3.439 × 10 − 12 |
| example | | | | | |

TABLE 2
Inspection of microorganism in bread packaged by the starch-based
composite active packaging film

| | Storage | | | Total number |
|---|---|---|---|---|
| | time | Escherichia coli | Molds | of colony |
| | (d) | (logCFU/g) | (logCFU/g) | (logCFU/g) |
| Embodiment | 1 | 2.01 ± 0.08 | 2.13 ± 0.07 | 3.10 ± 0.14 |
| 1 | 4 | 2.25 ± 0.42 | 3.19 ± 0.35 | 4.83 ± 0.66 |
| | 7 | 2.69 ± 0.12 | 4.27 ± 0.06 | 5.21 ± 0.11 |
| Comparison | 1 | 2.73 ± 0.21 | 3.65 ± 0.13 | 4.22 ± 0.12 |
| example | 4 | 4.34 ± 0.39 | 5.18 ± 0.22 | 6.28 ± 0.04 |
| | 7 | — | — | — |

“—” means that no measurement is conducted since the food is obviously moldy or spoilage.

From the above tables, it may be known by the comparison between the starch-based composite film containing the natural sustained-release antimicrobial agent and the starch film that the food packaging film prepared in the embodiments of the present invention exhibits excellent mechanical properties, slightly decreased transparency, significantly decreased water-blocking properties, and high inhibition against molds. Therefore, when compared to the comparison example, the food packaging film of the present invention has better overall performance.

The above is only the preferred embodiments of the present invention, and is not intended to limit the scope of the present invention. Any person skilled in the art may make changes or modifications to the mentioned-above technical contents to form equivalent embodiments that are then applied in other fields. However, any simple modifications, equivalent changes and modifications to the above embodiments in accordance with the technical essence of the present invention, without departing from the technical solutions of the present invention, shall be within the protection scope of the technical solutions of the present invention.

What is claimed is:

1. A method for preparing a food packaging film with antibacterial activity, comprising:
sufficiently dissolving cyclodextrin in deionized water to prepare a cyclodextrin solution, and dissolving perilla oil in ethanol to obtain a perilla oil solution;
mixing the cyclodextrin solution with the perilla oil solution, and magnetically stirring the reaction mixture under sealing and insulation to embed the perilla oil in the cyclodextrin to obtain an embedded product;
filtering the embedded product to remove extra cyclodextrin, freezing and lyophilizing the filtrate, and sealing and storing the lyophilized product in a cool and dark place;
dissolving a high-amylose corn starch in deionized water to obtain a starch dispersion, uniformly mixing the starch dispersion followed by stirring under heating to obtain a starch solution;
processing the starch solution in an autoclave to gelatinize the high-amylose corn starch to obtain a starch paste;
adding konjac glucomannan and glycerin to the starch paste, adding the lyophilized product obtained in step (3), and uniformly mixing the reaction mixture under magnetic stirring to obtain a film-forming liquid; and
degassing the film-forming liquid under vacuum, subjecting the degassed film-forming liquid to tape casting to produce a crude film, and quickly drying the crude film by an infrared tunnel dryer to produce a starch-based composite film containing cyclodextrin supermolecules as the food packaging film.

2. The method of claim 1, wherein in step (1), the cyclodextrin solution comprises 2%-6% by weight of cyclodextrin; the perilla oil solution comprises 20%-60% (w/v) of the perilla oil, and is prepared according to a core-to-wall ratio by mass of 1:6-10; and
the cyclodextrin is β-cyclodextrin or hydroxypropyl-β-cyclodextrin.

3. The method of claim 1, wherein in step (2), the magnetic stirring is performed at 40-60° C. and 200-220 rpm for 3-5 h; and a volume ratio of the cyclodextrin solution to the perilla oil solution is (90-100):1.

4. The method of claim 1, wherein in step (3), the freezing is performed at −20 to −25° C. for 24-48 h; and the lyophilization lasts for 45-50 h.

5. The method of claim 1, wherein in step (4), the starch dispersion comprises 3%-5% by weight of the high-amylose corn starch; and the stirring under heating is performed at 85-95° C. and 200-220 rpm for 25-35 min.

6. The method of claim 1, wherein in step (5), the gelatinization is performed at 125-130° C. and 2.0 MPa for 25-30 min.

7. The method of claim 1, wherein in step (6), the embedded product is 1%-5% by weight of the konjac glucomannan, glycerin and the starch paste; the magnetic stirring is performed at room temperature and 400-450 rpm for 40-60 min; the konjac glucomannan and the glycerin are respectively 0.2%-0.5% and 1%-2% by weight of the starch paste; in step (7), the degassing is performed at a vacuum degree of 0.08-0.1 MPa for 5-15 min; and the drying is performed at 50-60° C. for 3-5 h.

8. Use of the food packaging film of claim, comprising:
applying the food packaging film in the packaging of food.

9. Use of the food packaging film of claim 1, comprising:
applying the food packaging film to the packaging of candies, hawthorn rolls, jerky or bread.
